(19) United States
(12) Patent Application Publication
(10) Pub. No.: US 2026/0316881 A1
(43) Pub. Date: Oct. 15, 2026

(54) Method for Automated Stabilization of an Attitude of a Bicycle, Controller, Computer Program Product, Computer-Readable Medium, Bicycle

(71) Applicant: ZF Friedrichshafen AG, Friedrichshafen (DE)

(72) Inventors: Alexander Jungaberle, Schlier (DE); Uwe Schraff, Markdorf (DE); Markus Wallner, Friedrichshafen (DE); Peter Seidel, Oberteuringen (DE)

(21) Appl. No.: 19/116,618

(22) PCT Filed: Sep. 28, 2022
(86) PCT No.: PCT/EP2022/076987

§ 371 Date: Mar. 28, 2025

(51) Int. Cl. B62M 6/50; B62J 45/20; B62L 3/00

(52) U.S. Cl. CPC B62M 6/50; B62J 45/20; B62L 3/00

(57) ABSTRACT

A method for the automated stabilization of an attitude of a bicycle performing a jump includes: determining a current pitch angle of the bicycle; comparing the current pitch angle with a pitch angle threshold range; introducing a brake intervention or a negative torque pulse at a rear wheel of the bicycle when the current pitch angle exceed the pitch angle threshold range so that the pitch angle is subsequently within the pitch angle threshold range; and introducing a positive torque pulse at the rear wheel of the bicycle when the current pitch angle is below the pitch angle threshold so that the pitch angle is subsequently within the pitch angle threshold range.

### CROSS-REFERENCE TO RELATED APPLICATION

The present application is related and is a nationalization of PCT/EP2022/076987 filed in the European Patent Office on Sep. 28, 2022, which is incorporated by reference in its entirety for all purposes.

### FIELD OF THE INVENTION

The invention relates generally to a method for automated stabilization of an attitude of a bicycle, to a control device, to a computer program product, to a computer-readable medium, and to a bicycle.

### BACKGROUND

Bicycles having an electrical (auxiliary) propulsion means, for example, e-bikes and pedelecs, are becoming increasingly popular. Sporty electric mountain bikes (eMTB) are also in use. These eMTBs are also suitable for riding on obstacles on a terrain, in bike parks, or the like, and for performing jumps. Performing jumps with control requires ad-vanced skills on the part of the rider, however. An incorrect jump technique can quickly result in a crash, since incorrect balance, incorrect weight shifting, or incorrect timing already during take-off results in a critical attitude, which in most cases can no longer be corrected. The level of difficulty is additionally increased due to the greater weight of the eMTB in comparison to a regular mountain bike without an electrical (auxiliary) propulsion means. Beginners in particular are overwhelmed.

DE 10 2006 036 650 A1 describes a method for the prevention and/or regulation of the front wheel lifting on a motorcycle.

### SUMMARY OF THE INVENTION

The problem addressed by the invention is that of increasing safety also for inexperienced riders when performing jumps with bicycles having an electrical (auxiliary) propulsion means.

In a method for automated stabilization of an attitude of a bicycle, when the bicycle performs a jump, a current pitch angle of the bicycle is determined. The current pitch angle is compared with a pitch angle threshold range. If the current pitch angle exceeds the pitch angle threshold range, a brake intervention or a negative torque pulse is then introduced at a rear wheel of the bicycle, so that the pitch angle is subsequently within the pitch angle threshold range, or, if the current pitch angle is below the pitch angle threshold range, a positive torque pulse is introduced at the rear wheel of the bicycle, so that the pitch angle is subsequently within the pitch angle threshold range.

The term “bicycle” refers, in this case, to all bicycles which have both an electrical (auxiliary) propulsion means and a drive operated by muscle power, wherein the bicycle can be propelled either purely by muscle power or purely electrically or, in the hybrid mode, both by muscle power and electrically. In any case, the bicycle has a crank unit and an electrical propulsion system. The bicycle can also have a bicycle transmission, which can be, for example, a multi-speed transmission of planetary design, or a CVT transmission, or the like. The bicycle transmission can then be operatively connected to the electrical propulsion system. The bicycle transmission can also be operatively connected to the crank unit. The bicycle transmission can be a bottom bracket transmission or a hub gear. The bicycle can be, for example, an e-bike, a (high-speed) pedelec, an eMTB, or another suitable vehicle.

The method can be activated, while the bicycle is being ridden, either by the bicycle rider when the rider wants assistance when performing jumps with the bicycle, or the method can be permanently active, so that the method is automatically carried out during each jump. The method can also be deactivated by the rider when the rider does not want assistance when performing jumps with the bicycle.

An attitude is understood to mean any position of the bicycle in which the wheels of the bicycle are completely in the air and the bicycle no longer has contact with the ground. A distinction can be made between a stable attitude and a critical attitude. A stable attitude is present when the bicycle, including the rider, is located in the air such that a safe landing can be carried out, so that the rider can easily continue riding after finishing the jump. In particular, the riding dynamics, specifically yaw motions, pitching movements, and rolling movements, enable a safe landing. A critical attitude is present when the bicycle, including the rider, is located in the air such that a safe landing cannot be carried out, so that the bicycle tilts or overturns after finishing the jump, such that the rider crashes.

In a first step of the method, it is determined whether the bicycle is performing a jump. This is carried out preferably by acceleration sensors, wherein the acceleration can be determined with respect to all three coordinate axes of the bicycle. Alternatively, this can be carried out by at least one yaw rate sensor. The acceleration sensors or the yaw rate sensor can, for example, be installed on the bicycle or be part of an external unit, for example, a mobile terminal such as a smartphone, a smartwatch, a fitness tracker, or the like. Alternatively or additionally, the jump can be detected by the compression of the bicycle suspension fork. If this is not compressed, but rather hangs freely in the air, this indicates that the bicycle has no contact with the ground. This can be determined by sensors by, for example, determining the suspension travel.

The sensor data are transmitted to the controller on the bicycle. For this purpose, the control device is connected to the corresponding sensors for signal exchange. A connection which permits an exchange of signals is one in which data and signals are exchanged between the connection partners. For this purpose, each connection partner has a corresponding interface. The data and signal transmission can be carried out either in a hard-wired manner or a wireless manner. The control device and the corresponding sensors therefore have interfaces which permit such a connection. When the sensor data of the external unit are to be used, data and signals are exchanged between the external unit and the control device of the bicycle, for example, via a radio link or by hard-wired communication.

If a jump is detected, the second step of the method is carried out, specifically determining the current pitch angle of the bicycle. A pitch angle refers to the angle that the bicycle assumes when it is moved about the transverse axis of the bicycle, i.e., a pitching movement in the sense of vehicle dynamics. The transverse axis in this case is a purely geometric axis which extends parallel to the crank axle. A pitch angle of 0° corresponds to travel of the bicycle on a level, straight route. A positive pitch angle corresponds to a raising of a front wheel of the bicycle. A negative pitch angle corresponds to a lowering of the front wheel of the bicycle. The pitch angle is determined using sensors. For example, the pitch angle can be determined by an inclination angle sensor on the bicycle. Alternatively, the pitch angle can be determined by the sensor system of the external unit located on the bicycle.

Then, in a third step, the current pitch angle is compared with a pitch angle threshold range. The pitch angle threshold range includes the possible pitch angle which the bicycle can assume during a jump, so that a safe landing is subsequently possible. For example, the pitch angle threshold range can cover the range [−25°, 25°], the range [−20°, 20°], the range [−15°, 15°], the range [−20°, 0°], the range [−25°, 0°], the range [−15°, 0°], or also other suitable pitch angle ranges. It has been shown that a pitch angle of −25° or 25° is a limit value for a landing after a jump that is just barely safe.

The term “threshold” or “threshold range” does not refer to a global limit value which cannot be physically exceeded or fallen below. Rather, this is a certain value, which a user has established. All value indicators are understood to include tolerances.

If the determined current pitch angle is within the range of the pitch angle threshold range, a stable attitude is present. The rider can safely land with the bicycle after the jump. If the current pitch angle is outside the pitch angle threshold range, however, there are two alternatives for the fourth step of the method.

In the first alternative of the fourth step, the pitch angle exceeds the pitch angle threshold range. Consequently, the control device activates the electrical propulsion system of the bicycle, such that a negative torque pulse is introduced at the rear wheel of the bicycle. The wheel therefore rotates during the jump in the direction counter to the direction of propulsion. Alternatively, the control device activates the braking system of the bicycle, so that a braking torque is introduced at the rear wheel. The braking system can include, for example, an ABS system. Due to both measures, the pitch angle is reduced, so that the pitch angle is still within the pitch angle threshold range. As a result, the attitude of the bicycle stabilizes and the rider can land safely and easily after the jump.

In the second alternative of the fourth step, the pitch angle is below the pitch angle threshold range. Consequently, the control device activates the electrical propulsion system of the bicycle, such that a positive torque pulse is introduced at the rear wheel of the bicycle. The wheel therefore rotates in the direction of propulsion during the jump. Due to this measure, the pitch angle is increased, so that the pitch angle is still within the pitch angle threshold range. As a result, the attitude of the bicycle stabilizes in this case as well and the rider can land safely and easily after the jump.

According to one development, the intensity of the positive torque pulse and/or of the negative torque pulse and/or of the brake intervention depends on the difference between the pitch angle threshold range and the current pitch angle. In other words, a computational model is used to calculate, on the basis of the difference, how strong the particular torque pulse or the brake intervention must be so that the pitch angle assumes a predetermined value, for example, −15°, −10°, −20°, −25°, 0°, 15°, 10°, 20°, 25°, or similar suitable values. This predetermined pitch angle value can be, for example, identical for all jumps or can be calculated individually by another computational model depending on the bicycle load.

A control device for a bicycle is connectable to an electrical propulsion system of the bicycle for signal exchange, and the control device includes means for carrying out the method described above in the preceding description. The control device can be, for example, a domain ECU or an ECU.

When the control device is used in a bicycle, the control device is connected to the electrical propulsion system, specifically to the actuator system of the electrical propulsion system, for signal exchange, so that the control device can activate the actuator system. The control device can therefore request a positive torque pulse or a negative torque pulse. In addition, the control device can sense which torque is currently present.

When the control device is used in a bicycle, the control device is additionally connected to at least one sensor for signal exchange. The control device receives, for example, data regarding the acceleration, the yaw rate, and the pitch angle, and, optionally, data regarding the travel of the suspension fork, from the sensors. For example, the control device can be connected, for signal exchange, to an acceleration sensor or a yaw rate sensor, to an inclination angle sensor and/or to a mobile terminal, and, optionally, to a travel sensor for determining the suspension travel. When the control device is connected to the mobile terminal, the control device can receive data and signals from the mobile terminal that are acquired by the sensors in the mobile terminal. For example, the control device can use the inclination angle data, the speed data, the acceleration data, the GPS data, or the like, of the mobile terminal.

The control device is additionally connectable to a braking system of the bicycle for signal exchange. When the control device is used in a bicycle, the control device is additionally connected to the braking system for signal exchange, specifically to the actuator system of the braking system, such that the control device can activate the actuator system. The control device can therefore request a brake intervention.

A computer program product includes commands which, when the program is run by the above-described control device, prompt the control device to carry out the above-described method.

A computer-readable medium includes commands which, when run by the above-described control device, prompt the control device to carry out the above-described method. The computer-readable medium can be, for example, a data carrier or a down-loadable data stream.

The bicycle has an electrical propulsion system and the above-described control device, which electrical propulsion system is connected to the control device for signal exchange. The control device can therefore activate the actuator system of the electrical propulsion system, so that a positive torque pulse or a negative torque pulse can be re-quested. The bicycle can therefore carry out the above-described method for automated stabilization of an attitude of the bicycle.

The bicycle additionally has the crank unit. The electrical propulsion system has at least one electric motor and one electrical energy store. The bicycle also has the bicycle transmission. Both the crank unit and the electrical propulsion system are connected to the bicycle transmission. In addition, the bicycle includes multiple sensors, which are connected to the control device for signal exchange, for example, speed sensors, acceleration sensors, yaw rate sensors, travel sensors, inclination angle sensors, and/or a mobile terminal.

### BRIEF DESCRIPTION OF THE DRAWINGS

Exemplary embodiments of the invention are shown in the figures. Wherein:

FIG. 1 shows a schematic view of a bicycle according to one exemplary embodiment,

FIG. 2 shows a schematic view of a bicycle according to another exemplary embodiment,

FIG. 3 shows a schematic view of the bicycle from FIG. 1 or FIG. 2 in a stable attitude,

FIG. 4 shows a schematic view of the bicycle from FIG. 1 or FIG. 2 in a first critical attitude,

FIG. 5 shows a schematic view of the bicycle from FIG. 1 or FIG. 2 in a second critical attitude,

FIG. 6 shows a schematic view of a method sequence for the riding situations shown in FIG. 3, FIG. 4, and FIG. 5.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

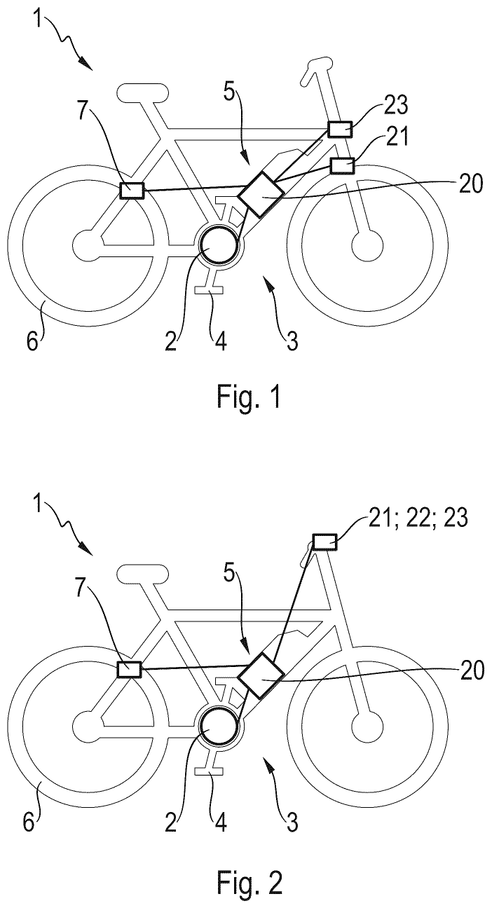

FIG. 1 shows a schematic view of a bicycle 1 according to one exemplary embodiment. The bicycle 1 is an e-bike or a pedelec or, in particular, an eMTB. The bicycle 1 has a crank unit, only the pedals 4 of which are shown for the sake of greater clarity. The bicycle 1 also has an electrical propulsion system 3, the electric motor of which is located, for example, at the bottom bracket. The electrical propulsion system 3 has an electrical energy store 5, which is connected to the electric motor. The electrical energy store 5 supplies the electric motor with electrical energy (operation as a motor) or is supplied with electrical energy by the electric motor (operation as a generator).

The bicycle 1 also has a bicycle transmission 2. The bicycle transmission 2 is a bottom bracket transmission. The bicycle transmission 2 is operatively connected to the electrical propulsion system 3 and to the crank unit. The bicycle 1 is therefore propelled either purely by muscle power or purely electrically or both by muscle power and electrically. The bicycle 1 has a braking system 7, which includes, for example, an ABS system. By the braking system 7, a rear wheel 6 of the bicycle 1 is decelerated.

The bicycle 1 has a control device or controller 20, which is connected to the electrical propulsion system 3, specifically to the actuator system of the electrical propulsion system 3, for signal exchange. In addition, the control device 20 is connected to the braking system 7, specifically to the actuator system of the braking system 7, for signal exchange. The control device 20 therefore activates both the braking system 7 and the electrical propulsion system 3.

In addition, the bicycle 1 has multiple sensors, which are connected to the control device 20 for signal exchange. The bicycle 1 has an acceleration sensor 21, which is designed to determine the current acceleration of the bicycle 1. This value is transmitted by the acceleration sensor 21 to the control device 20, enabling a determination to be made on the basis of the acceleration values as to whether the bicycle 1 is performing a jump. As an alternative to the acceleration sensor 21, a yaw rate sensor is provided, which yaw rate sensor is connected to the control device 20.

The bicycle 1 has an inclination angle sensor 23, which is designed to determine the current inclination angle of the bicycle 1. This value is transmitted by the inclination angle sensor 23 to the control device 20, enabling a determination to be made on the basis of the inclination angle values as to whether the bicycle 1 is in a stable attitude or a critical attitude.

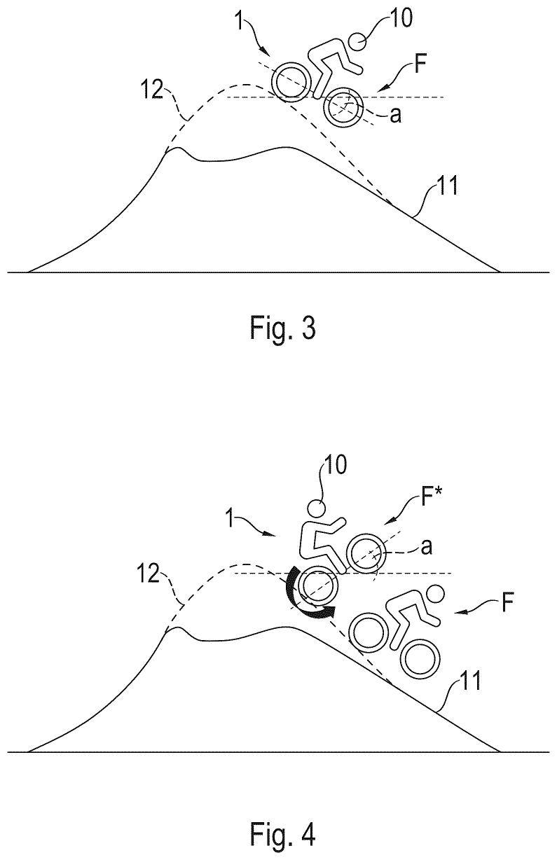

Proceeding from the values which have been acquired using sensors, a method for automated stabilization of an attitude is carried out, as shown in the method flow diagram in FIG. 6 for various riding situations according to FIGS. 3, 4, and 5.

FIG. 2 shows a schematic view of a bicycle 1 according to another exemplary embodiment. The bicycle 1 shown in FIG. 2 differs from the bicycle shown in FIG. 1 only in that, instead of the acceleration sensor and the inclination angle sensor, a mobile terminal 22, for example a smartphone, is provided. This mobile terminal 22 is connected to the control device 20 for signal exchange. The mobile terminal 22 is designed to determine a current inclination angle of the bicycle 1 and a current acceleration of the bicycle 1. The mobile terminal 22 transmits these values to the control device 20.

Proceeding from the values which have been acquired using sensors, the method for automated stabilization of an attitude is also carried out with this bicycle configuration, as shown in the method flow diagram in FIG. 6 for various riding situations according to FIGS. 3, 4, and 5.

FIG. 3 shows a schematic view of the bicycle 1 from FIG. 1 or FIG. 2 in a stable attitude F. A rider 10 performs a jump over a hilltop with the bicycle 1 on a route 11 of the bicycle. In the process, the rider describes a flight curve 12. The bicycle 1 assumes a pitch angle a which is within a pitch angle threshold range. The pitch angle a in this case is, for example, −20°. The pitch angle a is, for example, measured between a virtual horizontal plane and a virtual plane extending through the axes of rotation of the wheels of the bicycle. It is pointed out that all views in the figures are not true to scale. Once the jump has been completed, the rider 10 safely lands with the bicycle 1 on the route 11. The rider does not tilt or crash, since the attitude F of the rider was stable.

FIG. 4 shows a schematic view of the bicycle 1 from FIG. 1 or FIG. 2 in a first critical attitude F*. The rider 10 performs a jump over a hilltop with the bicycle 1 on a route 11 of the bicycle. In the process, the rider describes a flight curve 12. The bicycle 1 assumes a pitch angle a which is outside a pitch angle threshold range. The pitch angle a in this case is, for example, 35°. Once the jump has been completed, the rider 10 does not safely land with the bicycle 1 on the route 11. The rider would tilt or crash, since the attitude F* of the rider is critical.

The method for automated stabilization of the critical attitude F* is therefore carried out, which method is described with reference to FIG. 6. The rear wheel of the bicycle 1 is acted upon with a negative torque pulse and moved counter to the direction of propulsion. This is shown by the block arrow. Therefore, the bicycle 1 carries out a pitching movement in the air and assumes a pitch angle a which is within the pitch angle threshold range, for example, of −20°. As a result, a stable attitude F is subsequently present. Once the jump has been completed, the rider 10 safely lands with the bicycle 1 on the route 11. The rider does not tilt or crash, since the attitude F of the rider was stabilized by the method shown in FIG. 6.

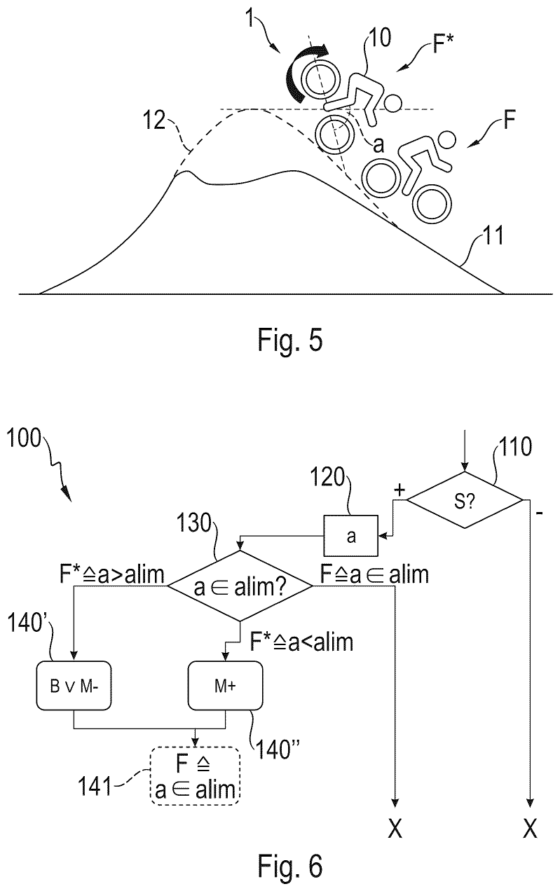

FIG. 5 shows a schematic view of the bicycle 1 from FIG. 1 or FIG. 2 in a second critical attitude F*. The rider 10 performs a jump over a hilltop with the bicycle 1 on a route 11 of the bicycle. In the process, the rider describes a flight curve 12. The bicycle 1 assumes a pitch angle a which is outside a pitch angle threshold range. The pitch angle a in this case is, for example, −85°. Once the jump has been completed, the rider 10 does not safely land with the bicycle 1 on the route 11. The rider would tilt or crash, since the attitude F* of the rider is critical.

The method for automated stabilization of the critical attitude F* is therefore carried out, which method is described with reference to FIG. 6. The rear wheel of the bicycle 1 is acted upon with a positive torque pulse and moved in the direction of propulsion. This is shown by the block arrow. Therefore, the bicycle 1 carries out a pitching movement in the air and assumes a pitch angle a which is within the pitch angle threshold range, for example, of −20°. As a result, a stable attitude F is subsequently present. Once the jump has been completed, the rider 10 safely lands with the bicycle 1 on the route 11. The rider does not tilt or crash, since the attitude F of the rider was stabilized by the method shown in FIG. 6.

FIG. 6 shows a schematic view of a method sequence for the riding situation shown in FIG. 3, FIG. 4, and FIG. 5. In the method flow diagram of the method 100 for automated stabilization of an attitude F, F* of a bicycle, an X indicates the termination of the method 100.

In a first step 110 of the method 100, it is determined by sensors whether the bicycle is performing a jump S. If this is not the case, the method 100 is terminated. If a jump S is detected, the second step 120 of the method 100 is carried out.

In the second step 120, the current pitch angle a of the bicycle is determined using sensors.

In a third step 130, the current pitch angle a is subsequently compared with the pitch angle threshold range alim. When the current pitch angle a is in the pitch angle threshold range alim, a stable attitude F is already present. Then, the method 100 is terminated.

When the current pitch angle a is not in the pitch angle threshold range alim, a critical attitude F* is present. If the current pitch angle a is greater than the pitch angle threshold value alim, the first alternative of the fourth step 140′ is carried out, a brake intervention B or a negative torque pulse M-being introduced at the rear wheel of the bicycle. If the current pitch angle a is less than the pitch angle threshold range alim, the second alternative of the fourth step 140″ is carried out, a positive torque pulse M-being introduced at the rear wheel of the bicycle.

As the result 141 of the two alternatives of the fourth step 140′, 140″, the pitch angle a is subsequently within the pitch angle threshold range alim. As a result, the bicycle assumes a stable attitude F.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 bicycle
2 bicycle transmission
3 electrical propulsion system
4 pedal
5 energy store
6 rear wheel
7 braking system
10 rider
11 route
12 flight curve
20 controller
21 acceleration sensor
22 mobile terminal
23 inclination angle sensor
100 method
110 first step
120 second step
130 third step
140′ fourth step, 1st alternative
140″ fourth step, 2nd alternative
141 result
a current pitch angle
alim pitch angle threshold range
F attitude
F* critical attitude
S jump
X termination of the method

1-8. (canceled)

9. A method (100) for the automated stabilization of an attitude (F, F*) of a bicycle (1), the method comprising, when the bicycle (1) is performing a jump (S):
determining a current pitch angle (a) of the bicycle (1);
comparing the current pitch angle (a) with a pitch angle threshold range (alim);
introducing a brake intervention (B) or a negative torque pulse (M-) at a rear wheel (6) of the bicycle (1) when the current pitch angle (a) exceeds the pitch angle threshold range (alim) so that the pitch angle (a) is subsequently within the pitch angle threshold range (alim); and
introducing a positive torque pulse (M+) at the rear wheel (6) of the bicycle (1) when the current pitch angle (a) is below the pitch angle threshold (alim) so that the pitch angle (a) is subsequently within the pitch angle threshold range (alim).

10. The method (100) of claim 9, further comprising determining the bicycle (1) is performing the jump(S) using at least one acceleration sensor (21) or at least one yaw rate sensor.

11. The method (100) of claim 9, wherein one or more of an intensity of the positive torque pulse (M+), an intensity of the negative torque pulse (M-), or an intensity of the brake intervention (B) depends on a difference between the pitch angle threshold range (alim) and the current pitch angle (a).

12. A control device (20) for the bicycle (1), wherein the control device (20) is connectable to an electrical propulsion system (3) of the bicycle (1) for signal exchange, wherein the control device (20) carries out the method (100) of claim 9.

13. The control device (20) for the bicycle (1) of claim 12, wherein the control device (20) is additionally connectable to a braking system (7) of the bicycle (1) for signal exchange.

14. A computer program product comprising commands which, when the program is run by the control device (20) of claim 12, prompt the control device (20) to carry out the method (100).

15. A computer-readable medium comprising commands which, when carried out by the control device (20) of claim 12, prompt the control device (20) to carry out the method (100).

16. A bicycle (1), comprising the electrical propulsion system (3) and the control device (20) of claim 12.
